(19) United States
(12) Patent Application Publication
(10) Pub. No.: US 2003/0056206 A1
(43) Pub. Date: Mar. 20, 2003

(54) Cross-barrier programming language

(76) Inventor: Frank Joseph Engo, Berkeley Heights, NJ (US)

Correspondence Address: FRANK J. ENGO, 934 LINDEN AVENUE, BRICKTOWN, NJ, 08723, US

(21) Appl. No.: 09/954,540

(22) Filed: Sep. 17, 2001

(51) Int. Cl. G06F 9/44

(52) U.S. Cl. 717/170

(57) ABSTRACT

Cross-Barrier is a new programming language that permits relatively seamless support for both online and offline applications. Programs written in Cross-Barrier will run on the Internet or off the Internet without having to reengineer the source code.

### FEDERALLY SPONDORED RESEARCH OR DEVELOPMENT

Not Applicable

### BACKGROUND OF INVENTION

With current technology, computer programs designed to work offline are often hard to port to the Internet. Moreover, applications written for the Internet cannot work offline typically without having to reengineer the code. The nature of Internet-based programs (hereby known as online applications) and desktop or private network applications (hereby known as offline applications) is fundamentally different and requires special and unique skills for a programmer to master each method of coding. With the present art, the coding styles of online and offline applications is so different, that attempts to bring programs online that were not designed to work online often results in failure. Often it is easier just to rewrite a program from scratch than it is to convert an offline application to an online application. The same problem holds true for online programs that need to be taken offline to improve speed and performance. The instructions for building online and offline applications are more typically different than they are the same. Online applications that have access to live data, usually rely on Web servers and middleware servers to access databases, pre-parse coding instructions and send the results back in HTML (HyperText Markup Language) or XML (Extended Markup Language) format to a Web browser. In contrast, an offline application can directly read from or write to a database without having to rely on any other server (although a database server may be desired to improve performance on a local area network). In special cases where an application has been designed to support a combination of online and offline features (i.e., a hybrid program), separate coding techniques must still be applied to support each environment. The computer programming language known as Java™ by Sun Microsystems®, does not address this problem by requiring entirely different coding techniques to write Java applets, servelets and applications. What is needed is a programming language that provides relatively seamless support for both online and offline applications.

### BRIEF SUMMARY OF THE INVENTION

The main objective of the invention is to provide a new computer programming language and standard that allows for the development of applications that run online and offline without having to change the source code. Specifically, the same set of coding instructions will run online or offline without the need to reengineer the software. By providing a common language that allows for the development of both types of programs, the learning curve to master the art of computer programming will be reduced, companies will save time and money not having to rewrite software to support online or offline versions of the same programs and there will be less need to depend on different programming languages to accomplish tasks that could have been performed in a more flexible programming language.

### BRIEF DESCRIPTION OF ILLUSTRATIONS AND APPENDIX

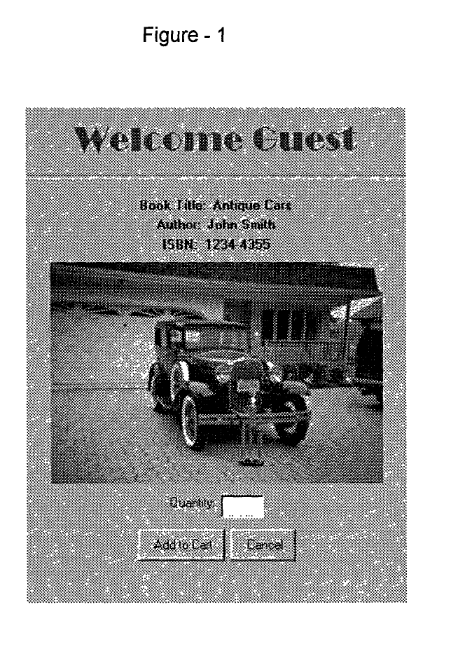

FIG. 1 shows how a sample program appears in the Cross-Barrier Interpreter.

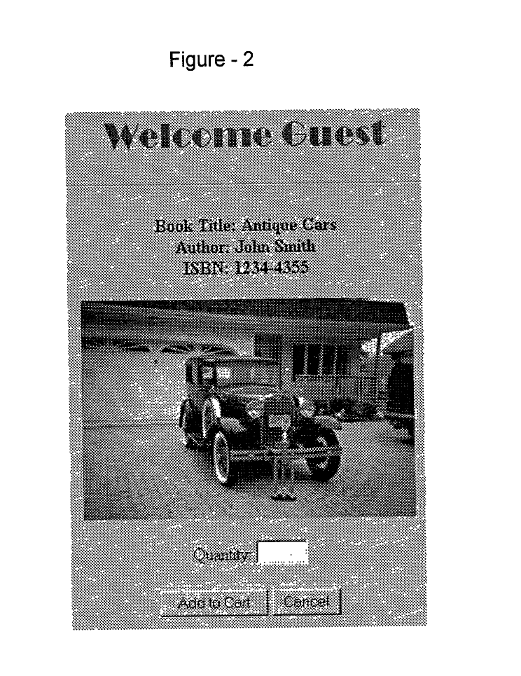

FIG. 2 shows how the same program appears is a Web browser when run through the Cross-Barrier Web Server.

Appendix A shows the source code for the sample Cross-Barrier program.

### DETAILED DESCRIPTION OF THE INVENTION

The Cross-Barrier programming language can be implemented in either of two ways:

Using the Cross-Barrier Web Server

Using the Cross-Barrier Interpreter

The Cross-Barrier Web Server runs Cross-Barrier applications over the Internet using the Hypertext Transfer Protocol (HTTP). The Cross-Barrier Interpreter runs programs in an offline mode on a single computer or in a local area network. Regardless of the method used to deploy the application, internally the code is still the same. Cross-Barrier is specifically designed so that source code will run online or offline without having to reprogram applications. It accomplishes this by providing a flexible set of instructions that can emulate HTML while providing additional capabilities such as access to databases and a common command syntax for developing both online and offline applications. An example of such a command is the ShowLink( ) function. When running through the Cross-Barrier Web Server, ShowLink( ) loads the Cross-Barrier script specified in its parameter list, parses it and passes the results back to the browser as an HTML document. Similarly, when ShowLink( ) is invoked from the Cross-Barrier Interpreter, the specified script will be invoked and the output produced by that Cross-Barrier script will also be rendered in a window. The results will appear virtually identical in most details. The only major difference is that unlike when a program is run through the Cross-Barrier Server, the Interpreter does NOT use HTML, a Web browser or a Web server to produce its output. Instead, it runs Cross-Barrier programs independently as stand-alone applications or shard applications on a private network. This is extremely important as the Interpreter is not an offline browser. It does not use or require HTML to produce its output. Instead, the Interpreter runs Cross-Barrier programs in a non-connected environment which can also be deployed if desired on the Internet.

For database access, the current implementation of Cross-Barrier supports its own native database format known as Cross-Barrier Database files. These are binary tables that are specifically made for easy deployment (i.e., no external database engine or database server is required). In its preferred embodiment, Cross-Barrier will eventually be opened to support other database formats.

Cross-Barrier is not limited to any particular type of application. The language can be used to produce a wide variety of programs including everything from maintaining a simple mailing list to producing accounting, financing and even scientific type applications. Cross-Barrier's floating-point math operations are accurate to 18-19 digits of decimal precision. Cross-Barrier was written in Borland® Delphi™ and runs on Windows based operating systems. In its preferred implementation, Cross-Barrier can be recompiled in Borland Kylix™ to support the Linux® operating system.

In special cases, Cross-Barrier provides commands that permit developers to add code to support features only applicable when the program is run from a certain environment. These included the CurApi( ) function and the Write( ) function. The CurApi( ) function determines whether a Cross-Barrier application is running in an online or offline mode. The Write( ) function passes HTML code directly to a Web browser. Output produced by the Write( ) method is ignored by the Cross-Barrier Interpreter and should only be used in advanced cases where it is not desired to support a particular feature in an offline application. These functions should not be considered as limitations of the language but more as extensions of it.

Regardless of the method used to run an application (online or offline), a common API (Application Programming Interface) allows for the easy development of programs. It includes a simple editor and debugger that permits developers to write a single set of coding instructions that will run in both online and offline environments.

[image]

[image]

1. What is claimed is that programs written in cross-barrier will run online (connected via the internet) or offline without having to maintain separate versions of the source code.
